(19) United States
(12) Patent Application Publication
(10) Pub. No.: US 2026/0046761 A1
(43) Pub. Date: Feb. 12, 2026

(54) REDUCING POWER CONSUMPTION IN ACCESS POINTS

(71) Applicant: Cisco Technology, Inc., San Jose, CA (US)

(72) Inventor: Sivadeep R. KALAVAKURU, Pleasanton, CA (US)

(21) Appl. No.: 18/796,119

(22) Filed: Aug. 6, 2024

(51) Int. Cl. H04W 52/02

(52) U.S. Cl. CPC H04W 52/0206

(57) ABSTRACT

The present disclosure provides techniques for reducing power consumption in wireless devices. A wireless device with one or more receiver chains receives signals from a plurality of client devices. The wireless device estimates a link budget for the plurality of client devices, where the link budget indicates a quality of the signals received from the plurality of client devices. The wireless device adjusts an amplifier bypass threshold for the one or more receiver chains based on the link budget.

### TECHNICAL FIELD

Embodiments presented in this disclosure generally relate to power consumption for wireless communication. More specifically, embodiments disclosed relate to dynamically adjusting the bypass threshold of an access point (AP) based on link budget analysis of a cluster of client devices to reduce power consumption.

### BACKGROUND

With the advent of Wi-Fi 6 and 7, access points (APs) are expected to support up to 16 transmitter (TX) and receiver (RX) chains. While moving to a higher number of radios operating at higher quadrature amplitude modulation (QAM) (like 1 K/4K QAM) is beneficial for improving system throughput, serving a larger number of clients, and enhancing TX/RX diversity, it also leads to an increase in power consumption. This increase is particularly notable at room temperature, where power consumption is much higher compared to previous AP generations that operated with lower QAM levels and fewer TX/RX chains. APs, both indoor and outdoor, are required to support modes of operation within a system power draw of less than 30.5 W, 25.5 W, or 13.8 W to comply with the IEEE 802.3bt/at/af Power over Ethernet (PoE) budget standards. For example, when using 802.3at switches, APs often need to disable multiple radios, reduce the number of TX/RX chains, and disable certain features (like USB, external module ports, or CPU throughput throttling) to operate within the available PoE budget. Moreover, the enterprise section is increasingly prioritizing energy-efficient deployments, making power management and optimization more necessary for the adoption of advanced AP technologies.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless device with a chipset and a front end module configured to perform various aspects of the present disclosure, according to some embodiments of the present disclosure.

FIG. 2 depicts micro and macro cell regions within an AP's coverage area, according to some embodiments of the present disclosure.

FIG. 3 depicts an example method for dynamic low noise amplifier (LNA) gain control based on link budget analysis, according to some embodiments of the present disclosure.

FIG. 4 is a flow diagram depicting an example method for adaptive bypass threshold control to reduce power consumption, according to some embodiments of the present disclosure.

FIG. 5 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by a wireless device with one or more receiver chains, signals from a plurality of client devices, estimating a link budget for the plurality of client devices, where the link budget indicates a quality of the signals received from the plurality of client devices, and adjusting an amplifier bypass threshold for the one or more receiver chains based on the link budget.

Other embodiments in this disclosure provide one or more non-transitory computer-readable media containing, in any combination, computer program code that, when executed by operation of a computer system, performs operations in accordance with one or more of the above methods, as well as a radio frequency front end of a wireless device comprising one or more receiver chains, each comprising a low noise amplifier (LNA) and a bypass path, one or more computer processors, and one or more memories collectively containing one or more programs, which, when executed by the one or more computer processors, perform operations in accordance with one or more of the above methods.

### Example Embodiments

With the development of increasingly complex wireless systems, modern APs can support up to 16 RX/TX chains. The increase in the number of chains, while beneficial for network capability and reliability, also leads to an increase in power consumption. In order to comply with existing PoE budget standards such as IEEE 802.3bt/at/af, APs with multiple RX/TX chains often need to disable radios, reduce the number of active chains, or disable certain features (like USB, external module ports, or CPU throughput throttling) to manage power usage effectively. Additionally, a number of studies have revealed that APs often consume more energy when receiving data than transmitting it.

The present disclosure introduces techniques for reducing power consumption in APs, allowing them to comply with the PoE budget standards without (or at least reducing) the need to disable other functions. Considering that some APs may tend to consume more energy when receiving signals than transmitting them, in some embodiments, the power consumption may be reduced by dynamically adjusting the bypass threshold of the Low Noise Amplifier(s) (LNA) across the AP's multiple RX chains. In some embodiments, real-time link budget analysis, which considers both the uplink signal strength and path loss characteristics of the connected client devices, may be used to adjust the bypass threshold.

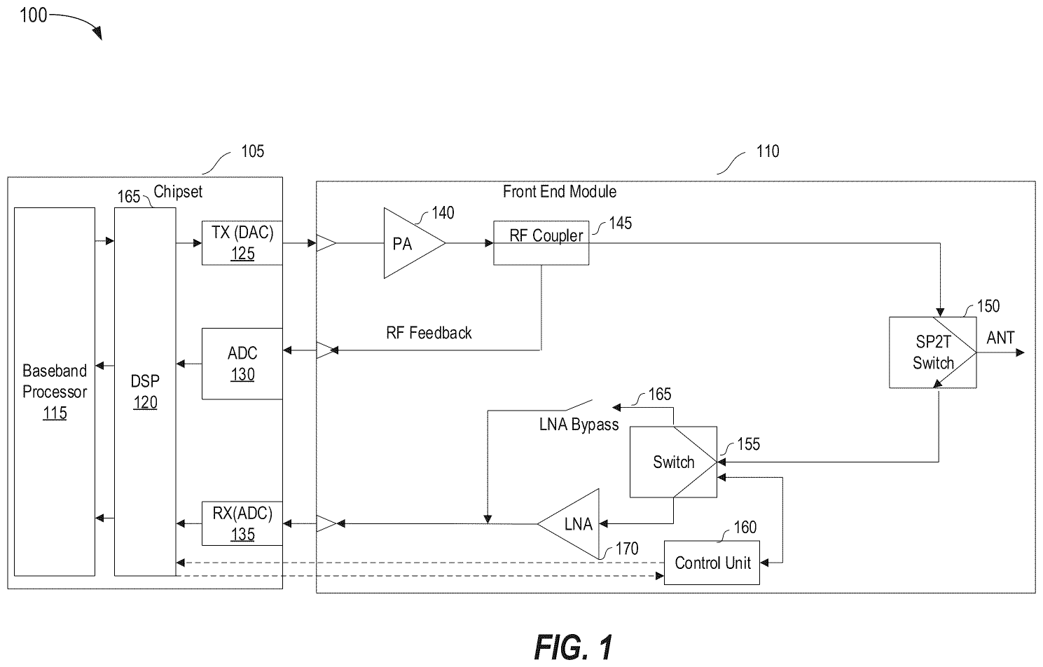

FIG. 1 depicts an example wireless device 100 with a chipset 105 and a front end module 110 configured to perform various aspects of the present disclosure, according to some embodiments of the present disclosure.

As illustrated, the example wireless device 100 consists of a chipset 105 and a front end module 110. The chipset 105 includes a baseband processor 115, a digital signal processor (DSP) 120, a transmitter (TX) 125, an analogy-to-digital converter (ADC) 130, and a receiver (RX) 135. In some embodiments, the chipset 105 may also be referred to as the Radio Frequency Integrated Circuit (RFIC). The baseband processor 115 is configured to convert digital data into an encoded signal for wireless communication. The encoded signal is then sent to the DSP 120 for advanced signal processing, such as error correction and modulation adjustments to ensure robust transmission. The processed signal is then passed to the TX 125, which converts the digital signal into an analog signal. In some embodiments, the TX 125 may function as a digital-to-analog converter (DAC).

As depicted in this figure, the analog signal is then directed to the power amplifier (PA) 140, which boosts the power of the signal. The boosting operation can help ensure that the signal is strong enough to travel long distances and overcome transmission losses. The RF coupler 145 receives the boosted signal, samples a small portion of the signal, and routes it to ADC 130 for monitoring or feedback purposes (e.g., error correction, modulation adjustment). The remaining portion of the boosted signal is then directed to the single pole double throw (SP2T) switch 150.

The SP2T switch 150 is configured to route the signal between the transmit and receive modes. In the transmit mode, as illustrated, the SP2T switch 150 directs the signal transmitted from the TX 125 to the antenna. In the receive mode, the SP2T switch 150 directs the signal received from the antenna to the RX 135. In some embodiments, the wireless device 100 may correspond to an AP. In such a configuration, the received signal by the AP may be referred to as an uplink signal, and the transmitted signal by the AP may be referred to as a downlink signal. The received uplink signal is forwarded by the SP2T switch 150 towards the switch 155. As depicted, the switch 155 is configured to route the received signal either directly through the LNA 170 or to bypass the LNA 170 (through the bypass circuit 165) to the RX 135. As used herein, the LNA's 170 function is to boost the signal strength of received signals, to ensure that weak signals received from client devices can be enhanced or improved to maintain communication.

As illustrated, the control unit 160 is coupled to the switch 155. The control unit is configured to monitor the strength of the received signal, and to forward this signal strength information to the DSP 120. In some embodiments, the DSP 120 may correspond to a computing device, such as a microcontroller, a Field-Programmable Gate Array (FPGA), or an embedded computer. In some embodiments, the DSP 120 may run specialized software to route the uplink signals based on real-time link budget analysis, reducing the wireless device's 100 power consumption while maintaining high quality of communication.

More specifically, in some embodiments, the DSP 120 may be programmed to establish two separate RX LNA bypass thresholds. As used herein, the RX LNA bypass threshold defines the power level at which the signal is considered strong enough to bypass the LNA 170. When the signal strength (also referred to in some embodiments as received power) is above the bypass threshold, the signal is directed to bypass the LNA 170. When the signal strength is below or equal to the threshold, the signal is directed through the LNA 170 for amplification.

When the client devices transmitting uplink signals are located within a defined micro cell region, the DSP 120 may maintain a low RX LNA bypass threshold. As used herein, the “micro cell region” may refer to an area within the AP's signal coverage where the client devices transmit uplink signals with higher signal strength and lower path loss, making a reduced RX LNA gain (e.g., 12 dB to 15 dB) sufficient to ensure quality communication without unnecessary signal amplification. By setting the low RX LNA bypass threshold (e.g., −48 dBm), the majority of received signals by the wireless device may be directed to bypass the LNA 170. As such, the wireless device 100 avoids unnecessary amplification, and consumes less energy when receiving signals. When the client devices move outside the micro cell region and enter the macro cell region, the DSP 120 may switch to a high RX LNA bypass threshold. As used herein, the macro cell region may include areas where signal coverage extends beyond the defined micro cell region, and where uplink signals from client devices may experience lower signal strengths and higher path loss as a result of increased distance or physical obstructions. The switch to the high RX LNA bypass threshold (e.g., −19 dBm) may ensure that the signal amplification is adequately increased to overcome the attenuation and maintain high quality of communication across longer distances.

In some embodiments, the micro cell region may be defined based on a set of criteria, such as received signal strength (RSSI), path loss, or other relevant environmental factors. The DSP 120 may perform link budget analysis on the received uplink signals to determine these parameters and compare them with predefined criteria. In some embodiments, a client device is considered to be within the micro cell region if its RSSI exceeds a defined signal strength threshold (e.g., −50 dBm), and/or its path loss remains below a defined level (e.g., 70 dB). For Wi-Fi networks, in some embodiments, a typical RSSI threshold for the micro cell region may be around −60 dBm to −50 dBm, indicating strong signal reception. A typical path loss for the micro cell region may be less than 70 dB, suggesting minimal degradation of the signals as they travel from the transmitter to the receiver. In embodiments where the wireless device 100 includes multiple TX/RX chains and is simultaneously transmitting and receiving data from multiple client devices, the average or weighted average RSSI and path loss values from these client devices may be calculated to make a decision about the region classification.

In some embodiments, these criteria may be dynamically adjusted using an algorithm that considers various factors, such as variations in network load or data priorities (for example, video streaming may have stricter requirements for bandwidth and signal quality than web browsing), the hardware capabilities of the client devices and the AP (such as receiver sensitivity, antenna configuration, and transmitter power), and levels of environmental interference (such as physical obstacles, electrical devices, or machinery). The dynamic adjustment in the criteria for defining the micro cell region allows the system to adapt to real-time changes in the network environment.

Based on the region classification and the real-time link budget analysis, the DSP 120 may determine the appropriate RX LNA bypass threshold (e.g., the low bypass threshold set for client devices within micro cell region, or the high bypass threshold set for client devices within macro cell region) to implement. Following the implementation, the DSP 120 may compare the RX LNA bypass threshold with the actual signal strength received. If the signal strength is higher than the threshold, it indicates that amplification is not necessary. In this configuration, the DSP 120 may transmit a control signal to the control unit 160, which controls the switch 155 to direct the uplink signal to bypass the LNA 170. Such a bypass may reduce the AP's power consumption. If the signal strength is equal to or falls below the threshold, it indicates that additional amplification is needed to maintain signal quality. In this configuration, the DSP 120 may transmit a control signal to the control unit 160, which controls the switch 155 to route the uplink signal through the LNA 170. As illustrated, the amplified uplink signal is then transmitted to the RX 135, which demodulates the signal to extract the data or information sent by the client device. By dynamically adjusting the RX LNA bypass threshold, the DSP 120 ensures that the LNA 170 is only used when necessary. As a result, power consumption of the example wireless device 100 can be effectively reduced without compromising the quality of uplink communication with the client devices.

As illustrated, the TX 125, the PA 140, the RF coupler 145, and the SP2T switch 150, combined together, form a TX chain that generates RF signals to the antenna for downlink transmission. The RX 135, the LNA 170, the switch 155, and the SP2T switch 150, combined together, form a RX chain that processes RF signals from the antenna for uplink transmission. The figure depicts the example wireless device having one RX chain and one TX chain for conceptual clarity. In some embodiments, the chipset 105 may include multiple RX and TX circuits, and the front-end module may include additional components such as PAs, RF couplers, switches, and LNAs that form multiple RX chains and TX chains, supporting multiple client devices with enhanced performance.

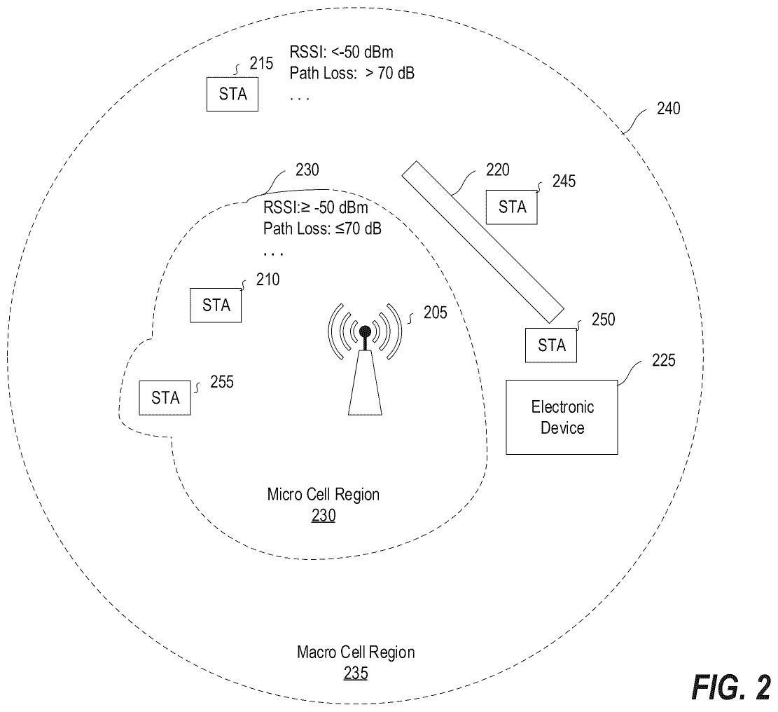

FIG. 2 depicts micro and macro cell regions within an AP's coverage area, according to some embodiments of the present disclosure.

This figure depicts an AP 205 and its overall signal coverage 240. In some embodiments, the AP 205 may correspond to the wireless device 100, as depicted in FIG. 1. As used herein, signal coverage 240 may refer to the area within which the AP 205 can effectively communicate with connected devices, such as transmitting and receiving signals that meet minimum quality standards. Within the coverage area 240, the AP 205 defines two zones based on signal quality: the micro cell region 230 and the macro cell region 235.

As used herein, the micro cell region 230 may refer to the area within the signal coverage that is close to the AP 205, where uplink signals transmitted by client devices (e.g., 210) satisfy defined criteria such that a reduced RX LNA gain (e.g., 12 dB to 15 dB) is sufficient to ensure high quality of communication. In some embodiments, these criteria for defining the micro cell region may include RSSI values, path loss values, distance from the AP, or other relevant factors. In the illustrated example, the micro cell region 230 is defined as the area where the RSSI of the uplink signal is equal to or higher than −50 dBm, and the path loss of the signal is equal to or less than 70 dB. Client devices 210 within this region may experience strong signal transmission/reception, and minimal signal degradation.

As used herein, the macro cell region 235 may include areas of signal coverage extending beyond the defined micro cell region 230. In the illustrated example, the macro cell region 235 is defined as the area where the RSSI of the uplink signal is lower than −50 dBm, or the path loss of the signal is higher than 70 dB (or both). Client devices 215 within this area may transmit/receive signals that are subject to substantial degradation and interference. Due to these challenging conditions, signals in the macro cell region 235 may require increased signal amplification (e.g., an increased RX LNA gain) to maintain communication standards, achieving an acceptable level of clarity and reliability.

Additionally, within the signal coverage area 240, the figure shows a physical obstacle 220 and an electronic device 225 that impact signal distribution. Near the obstacle 220 and the electronic device 225, the boundary of the micro cell region 230 contracts. This contraction occurs because the physical obstacle 220 may absorb or reflect parts of the signal, and the electronic device 225 may introduce electromagnetic interference. Both of these factors contribute to increased path loss and/or decreased RSSI. Therefore, client devices 245 and 250 that might have originally satisfied the required RSSI and path loss thresholds and been categorized within the micro cell region can no longer satisfy these criteria due to this interference, leading to their reclassification into the macro cell region 235.

In some embodiments, the micro cell region may extend depending on the hardware capabilities of the connected client devices and the level of environmental interference. For example, if the client device 255 is designed with high transmission power for uplink signals, the micro cell region 230 (requiring the RSSI of a received signal higher than −50 dBm) may expand to include this device 255. In some embodiments, if the physical obstacle 220 and the electronic device 255 that previously caused interference are removed, the micro cell region 230 may extend to include the client devices 245 and 250 that are near these interferences.

In some embodiments, the criteria for defining micro cell region, such as the RSSI threshold and the path loss threshold, may be dynamically adjusted considering factors such as changes in network load, the hardware capabilities of the AP and client devices, and the level of environmental interference. For example, if the AP 205 has high receiver sensitivity, the criteria for the micro cell region may be relaxed (e.g., the RSSI threshold may be decreased and the path loss threshold may be increased). Receiver sensitivity refers to the lowest signal strength at which an RX can detect a signal with a specified quality. With increased sensitivity, the AP's RX may detect and decode signals that are weaker and would previously fall below the threshold required for reliable communication. Because the AP 205 can handle weaker signals more effectively, the criteria for defining the micro cell region may be relaxed to expand the region to include client devices further away from the AP or those transmitting at lower power levels. This adjustment may be implemented based on the determination that the AP's increased receiver sensitivity can maintain high-quality communication even with a low RX LNA bypass threshold. In embodiments where there is high volume traffic (such as during video streaming service that requires high bandwidth and signal quality), or when environmental interference is significant (such as when the signal coverage includes several physical obstacles and electronic devices), the criteria for the micro cell region may be tightened (e.g., RSSI threshold may be increased and path loss threshold may be decreased). Such adjustment may ensure that the quality of communication is maintained by adapting a high RX LNA bypass threshold to enhance signal amplification. In some embodiments, machine learning (ML) models may be used to predict values (e.g., RSSI, path loss, distance) for defining micro cell region based on historical data and observed patterns. The ML models may adapt to a wide range of variables, including, but not limited to, changes in received signal strength, variations in network loads, the hardware capabilities of AP and connected client devices, and environmental interference factors.

Although the illustrated AP defines two zones (micro cell region 230 and macro cell region 235) for the purpose of applying corresponding LNA bypass thresholds based on the estimated link budget, the illustrated example is provided for conceptual clarity. In some embodiments, the AP's signal coverage may be divided into micro, meso and macro cell regions, with each region having its own designated LNA bypass threshold. In some embodiments, the segmentation of signal coverage may be more granular, and any number of cell regions and corresponding LNA bypass thresholds may be defined.

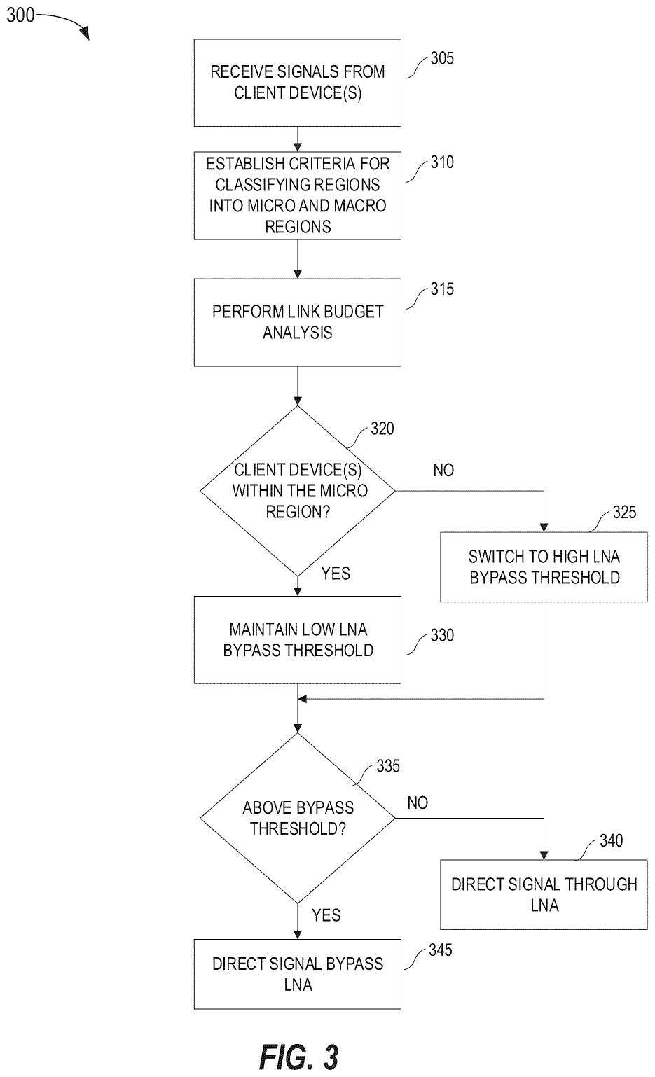

FIG. 3 depicts an example method 300 for dynamic LNA gain control based on link budget analysis, according to some embodiments of the present disclosure. In some embodiments, the method 300 may be performed by an AP, such as the wireless device 100 as depicted in FIG. 1, or the AP 205 as depicted in FIG. 2.

The method 300 begins at block 305, where an AP receives uplink signals from one or more connected client devices.

At block 310, the AP establishes criteria for defining micro and macro cell regions with the AP's signal coverage area. Such definition may optimize (or at least improve) power consumption and ensure effective signal processing. As discussed above, the micro cell region (e.g., 230 of FIG. 2) may refer to the areas within close proximity to the AP (e.g., 205) where client devices transmit and receive signals with strong signal strength and minimal path loss. In some embodiments, the criteria for defining the micro cell region may include RSSI value, path loss value, distance from the AP, and other relevant factors. As depicted in FIG. 2, a client device (e.g., 210 of FIG. 2) that transmits an uplink signal to the AP with an RSSI higher than −50 dBm and path loss less than 70 dB is considered to be within the micro cell region. The AP serving this client device may set its RX LNA bypass threshold to a low value for reduced signal amplification, therefore saving power. In contrast, a client device (e.g., 215 of FIG. 2) that transmits an uplink signal to the AP with either an RSSI lower than −50 dBm or path loss greater than 70 dB is considered to be within the macro cell region. The AP serving this client device may require a high RX LNA bypass threshold to enhance signal amplification, to maintain the standard communications despite weaker single conditions.

At block 315, the AP performs link budget analysis on the received uplink signals. In some embodiments, the analysis may involve measuring the RSSI of the uplink signal at the point of reception by the AP, and calculating the path loss to evaluate how much of the signal has degraded as it traveled from the client device to the AP. In some embodiments, the path loss may be calculated by subtracting the measured received power (RSSI) from the known transmitted power of the client device:

Path Loss (dB)=Transmitted Power (dBm)−Received Power (dBm)

In embodiments where the AP includes multiple RX chains that are receiving uplink signals from multiple connected devices, the AP may aggregate the data from all uplink signals, collecting RSSI values and calculating individual path losses for each connected device. In some embodiments, the AP may compute either an average or a weighted average of the RSSI and path loss values, depending on the system design. Under the weighted average approach, weights assigned to devices may be prioritized based on factors such as service type, network load, and device capabilities, among others.

At block 320, based on the results from the link budget analysis, the AP determines whether the client device is located within the micro cell region, and therefore a low RX LNA bypass threshold can be maintained to save power consumption. In embodiments where the criteria for the micro cell region include specific RSSI and path loss values, the AP may assess whether the received signal strength exceeds the RSSI threshold and whether the path loss is lower than the set threshold. If the client device meets these criteria (measured RSSI above the set signal strength threshold and calculated path loss below the set path loss threshold), the AP may categorize the device as being within the micro cell region. The method 300 then proceeds to block 330, where the AP maintain a low RX LNA bypass threshold for routing the uplink signals. This setting may reduce the need for signal amplification and therefore, save power. If the client device does not meet these criteria (measured RSSI below the set signal strength threshold or calculated path loss above the set path loss threshold), the AP may determine that the client device fall outside the micro cell region and instead resides within the macro cell region. The method 300 then proceeds to block 325, where the AP switches a high RX LNA bypass threshold to enhance signal amplification.

As discussed above, in embodiments where the AP receives uplink signals from a cluster of client devices, the AP may compute the average RSSI and path loss, and compare these values with the respective thresholds. If both the average RSSI and path loss values satisfy the micro cell region criteria, the AP may classify these devices as being within the micro cell region, allowing the AP to maintain the low RX LNA bypass threshold (as depicted at block 330) and conserve power consumption. If, however, the averaged values indicate weaker RSSI or higher path loss, failing the micro cell region criteria, the AP may apply the high RX LNA gain settings to ensure adequate signal amplification and maintain communication quality (as depicted at block 325).

As used herein, the RX LNA bypass threshold defines the power level at which the signal is considered strong enough to bypass the LNA. When the signal strength (also referred to in some embodiments as received power) is above the bypass threshold, the signal is directed to bypass the LNA. When the signal strength is below or equal to the threshold, the signal is directed through the LNA for amplification.

In embodiments where the AP determines that the client device (or a cluster of the client devices) is within the micro cell region, defined by an RSSI higher than −50 dBm, it indicates that the uplink signals from the device are robust across the transmissions. In such a configuration, the AP may set a low RX LNA bypass threshold (e.g., −48 dBm), slightly above the RSSI threshold defining the micro cell region (e.g., −50 dBm). The low RX LNA threshold allows the majority of these strong signals to bypass the LNA, effectively conserving energy by reducing unnecessary amplification. Additionally, as the signals are already strong and clear (e.g., above −50 dBm), bypassing the LNA under these conditions does not compromise the quality of communication.

In embodiments where the AP determines that the client device (or a cluster of client devices) is within the macro cell region, characterized by an RSSI lower than −50 dBm or path loss higher than 70 dB, it indicates that the uplink signals from the device are relatively weak or have degraded significantly. In such a configuration, the AP may set a high RX LNA bypass threshold (e.g., −19 dBm), substantially above the RSSI threshold defining the micro cell region (e.g., −50 dBm). The high RX LNA gain may ensure these weak signals (falling below −19 dBm) are adequately amplified to maintain communication quality.

In some embodiments, the values for two separate RX LNA bypass thresholds (e.g., −19 dBm as the high LNA bypass threshold, and −48 dBm as the low LNA bypass threshold) may be adjusted depending on various factors, including, but not limited to, the signal quality requirements for different types of services, the environmental conditions where the AP operates, the hardware capabilities of both the AP and client devices, and compliance with regulatory standards. In some embodiments, the low RX LNA bypass threshold may be set to save power consumption by allowing the AP to bypass the majority of signals without compromising the quality of service. The low threshold may be applied when the client devices are within the micro cell region so that uplink signals are strong enough that additional amplification is unnecessary. In some embodiments, the high RX LNA bypass threshold may be set to guarantee adequate amplification for weaker signals, which might otherwise suffer from poor quality and unreliability.

At block 335, with the LNA bypass threshold implemented based on the region classification, the AP compares the RSSI (or received power) of the uplink signal against the set bypass threshold. The comparison is used to determine whether the signal is strong enough to be processed without additional amplification. If the signal strength exceeds the bypass threshold (e.g., −48 dBm), it indicates that no further amplification is needed. The method 300 proceeds to block 345, where the AP directs the uplink signal bypassing the LNA and directly to the RX circuit (e.g., 135 of FIG. 1). If the signal does not meet the threshold (e.g., −48 dBm), it indicates that the signal is too weak and requires amplification to reach an acceptable level for quality communication. The method 300 proceeds to block 340, where the AP routes the uplink signal through the LNA for amplification.

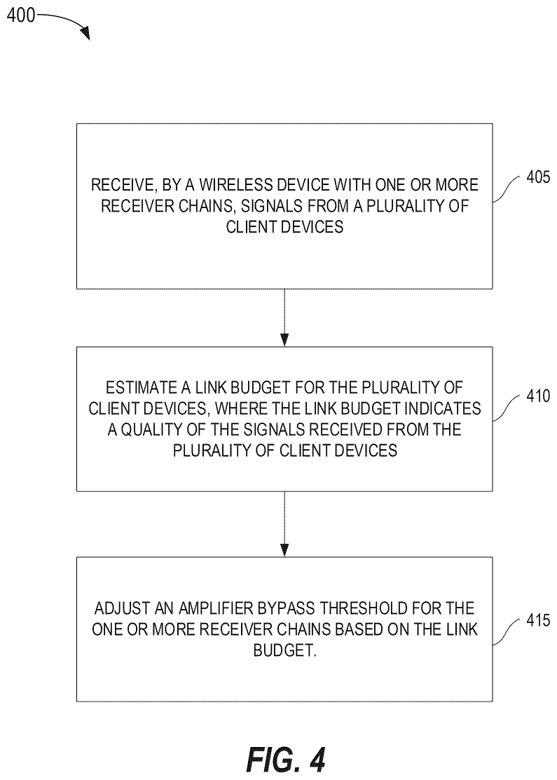

FIG. 4 is a flow diagram depicting an example method for adaptive bypass threshold control to reduce power consumption, according to some embodiments of the present disclosure.

At block 405, a wireless device (e.g., AP 205 of FIG. 2) with one or more receiver chains receives signals from a plurality of client devices (e.g., 210 of FIG. 2).

At block 410, the wireless device estimates a link budget for the plurality of client devices (as depicted at block 315 of FIG. 3), wherein the link budget indicates a quality of the signals received from the plurality of client devices. In some embodiments, when estimating the link budget, the wireless device may calculate at least one of an average of signal strengths associated with the signals received from the plurality of client devices, or an average of estimated path losses associated with the signals received from the plurality of client devices.

At block 410, the wireless device adjusts an amplifier bypass threshold for the one or more receiver chains based on the link budget (as depicted at blocks 320-330 of FIG. 3).

In some embodiments, the wireless device may further establish one or more criteria for region classification based on at least one of received signal strengths, hardware capabilities of the plurality of client devices, environmental interference levels, and network load (as depicted at block 310 of FIG. 3).

In some embodiments, upon determining that the link budget satisfies the one or more established criteria for region classification, the wireless device may identify that the plurality of client devices is within a micro cell region of the wireless device (as depicted at block 320 of FIG. 3).

In some embodiments, when adjusting the amplifier bypass threshold for the one or more receiver chains based on the link budget, the wireless device may, subsequent to identifying that the plurality of client devices is within the micro cell region of the wireless device, decrease the amplifier bypass threshold to a first value (as depicted at block 330 of FIG. 3).

In some embodiments, upon determining that the link budget does not satisfy the one or more established criteria for region classification, the wireless device may identify that the plurality of client devices is within a macro cell region of the wireless device (as depicted at block 320 of FIG. 3).

In some embodiments, when adjusting the amplifier bypass threshold for the one or more receiver chains based on the link budget, the wireless device may, subsequent to identifying that the plurality of client devices is within the macro cell region of the wireless device, increase the amplifier bypass threshold to a second value (as depicted at block 325 of FIG. 3).

In some embodiments, each of the one or more receiver chains may comprise a low noise amplifier (LNA). In some embodiments, the wireless device may comprise an AP or a station (STA).

In some embodiments, upon determining that a signal strength associated with one of the received signals exceeds the amplifier bypass threshold, the wireless device may direct the signal to bypass the LNA within a respective receiver chain.

In some embodiments, upon determining that a signal strength associated with one of the received signals is equal to or falls below the amplifier bypass threshold, the wireless device may direct the signal through the LNA within a respective receiver chain to boost the signal strength.

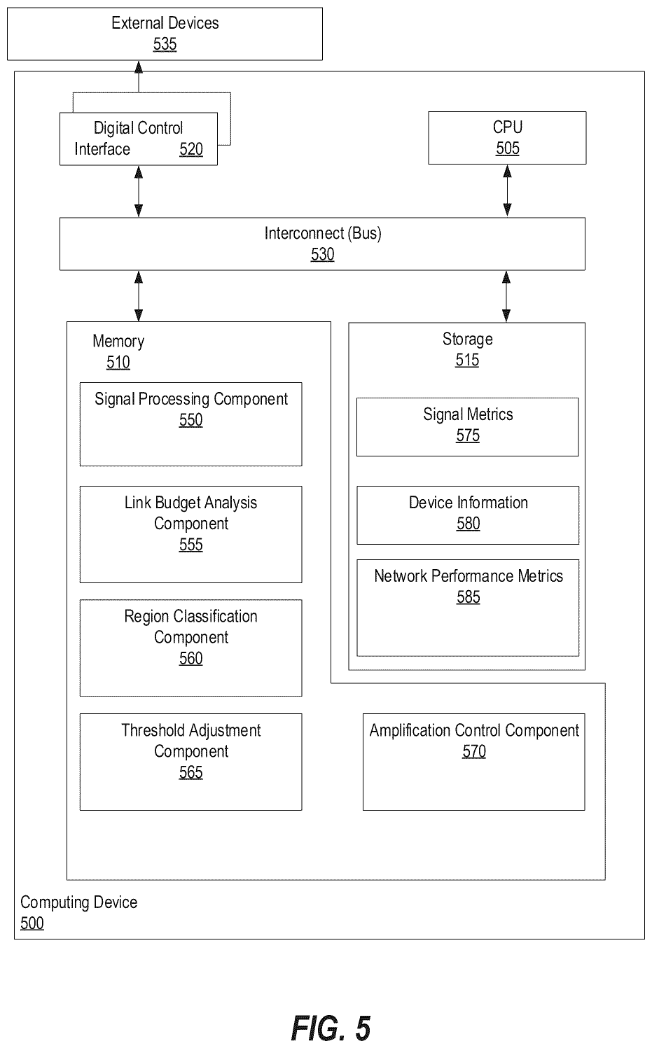

FIG. 5 depicts an example computing device 500 configured to perform various aspects of the present disclosure, according to one embodiment. In some embodiments, the computing device 500 may correspond to the DSP 120 as depicted in FIG. 1.

As illustrated, the computing device 500 includes a CPU 505, memory 510, storage 515, and one or more digital control interfaces 520. Each of the components is communicatively coupled by one or more buses 530.

The CPU 505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The CPU 505 retrieves and executes programming instructions stored in memory 510, as well as stores and retrieves application data residing in storage 515. The digital control interface 520 may send control signals to external devices (e.g., the control unit 160 of FIG. 1).

The memory 510 may include random access memory (RAM) and read-only memory (ROM). The memory 510 may store processor-executable software code containing instructions that, when executed by the CPU 505, enable the device 500 to perform various functions described herein for wireless communication. In the illustrated example, the memory 510 includes five software components: the signal processing component 550, the link budget analysis component 555, the region classification component 560, the threshold adjustment component 565, and the amplification control component 570. In some embodiments, the signal processing component 550 may interface with the hardware to measure the RSSI values of the received uplink signals. In some embodiments, the link budget analysis component 555 may estimate path loss based on the RSSI values (measured by signal processing component 550), transmitter power of the client devices, and any relevant environmental factors that may affect signal propagation. In some embodiments, the link budget analysis component 555 may evaluate the level of environmental interference using signal quality metrics, historical data, and environmental inputs (e.g., physical obstacles, electronic devices). In some embodiments, based on the results from the link budget analysis, the region classification component 560 may compare the analyzed data with predefined criteria to determine whether the client device (or a cluster of client devices) transmitting the uplink signals is located within the micro or macro cell regions. In some embodiments, the predefined criteria may be dynamically adjusted in response to changes in network conditions and environmental factors. In some embodiments, the threshold adjustment component 565 may adjust RX LNA bypass threshold based on the region classification results. The component 565 may apply a low RX LNA gain to save power when client devices are located within micro cell region, and switch to a high RX LNA gain to enhance signal amplification when client devices enter the macro cell region. In some embodiments, the amplification control component 570 may compare the applied threshold with the RSSI of the received signal to determine the appropriate routing for the signal, either bypassing the LNA or directing it through the LNA for amplification. In some embodiments, the amplification control component 570 may generate and transmit control signals to the hardware control unit (e.g., 160 of FIG. 1) based on the comparison to ensure the received signals are properly routed, aligning with the signal quality requirements of the network.

The storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 515 may store a variety of data for the efficient functioning of the system. The data may include historical signal metrics 575 (including RSSI values of received signal, path loss, and other relevant signal quality metrics), device information 580 (including data about the hardware capabilities of connected client devices and AP, such as device type, transmitter power, and receiver sensitivity), network performance metrics 585 (including data related to network traffic loads, throughput rates, error rates, and service quality metrics).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a wireless device with one or more receiver chains, signals from a plurality of client devices;
estimating a link budget for the plurality of client devices, wherein the link budget indicates a quality of the signals received from the plurality of client devices; and
adjusting an amplifier bypass threshold for the one or more receiver chains based on the link budget.

2. The method of claim 1, wherein estimating the link budget comprises calculating at least one of an average of signal strengths associated with the signals received from the plurality of client devices, or an average of estimated path losses associated with the signals received from the plurality of client devices.

3. The method of claim 1, further comprising establishing one or more criteria for region classification based on at least one of received signal strengths, hardware capabilities of the plurality of client devices, environmental interference levels, and network loads.

4. The method of claim 3, further comprising, upon determining that the link budget satisfies the one or more established criteria for region classification, identifying that the plurality of client devices is within a micro cell region of the wireless device.

5. The method of claim 4, wherein adjusting the amplifier bypass threshold for the one or more receiver chains based on the link budget comprises, subsequent to identifying that the plurality of client devices is within the micro cell region of the wireless device, decreasing the amplifier bypass threshold to a first value.

6. The method of claim 3, further comprising, upon determining that the link budget does not satisfy the one or more established criteria for region classification, identifying that the plurality of client devices is within a macro cell region of the wireless device.

7. The method of claim 6, wherein adjusting the amplifier bypass threshold for the one or more receiver chains based on the link budget comprises, subsequent to identifying that the plurality of client devices is within the macro cell region of the wireless device, increasing the amplifier bypass threshold to a second value.

8. The method of claim 1, wherein each of the one or more receiver chains comprises a low noise amplifier (LNA).

9. The method of claim 8, further comprising, upon determining that a signal strength associated with one of the received signals exceeds the amplifier bypass threshold, directing the signal to bypass the LNA within a respective receiver chain.

10. The method of claim 8, further comprising, upon determining that a signal strength associated with one of the received signals is equal to or falls below the amplifier bypass threshold, directing the signal through the LNA within a respective receiver chain to boost the signal strength.

11. The method of claim 1, wherein the wireless device comprises at least one of an access point (AP) or a station (STA).

12. A radio frequency front end of a wireless device, comprising:
one or more receiver chains, each comprising a low noise amplifier (LNA) and a bypass path;
one or more computer processors; and
one or more memories collectively containing one or more programs, which, when executed by the one or more computer processors, perform operations, the operations comprising:
receiving signals from a plurality of client devices;
estimating a link budget for the plurality of client devices, wherein the link budget indicates a quality of the signals received from the plurality of client devices; and
adjusting an amplifier bypass threshold for the LNA within the one or more receiver chains based on the link budget.

13. The radio frequency front end of the wireless device of claim 12, wherein, to estimate the link budget, the one or more programs, which, when executed by the one or more computer processors, perform the operations comprising calculating at least one of an average of signal strengths associated with the signals received from the plurality of client devices, or an average of estimated path losses associated with the signals received from the plurality of client devices.

14. The radio frequency front end of the wireless device of claim 12, wherein the one or more programs, which, when executed by the one or more computer processors, perform the operations further comprising, upon determining that the link budget satisfies one or more established criteria for region classification, identifying that the plurality of client devices is within a micro cell region of the wireless device.

15. The radio frequency front end of the wireless device of claim 14, wherein, to adjust the bypass threshold, the one or more programs, which, when executed by the one or more computer processors, perform the operations comprising, subsequent to identifying that the plurality of client devices is within the micro cell region of the wireless device, decreasing the amplifier bypass threshold to a first value.

16. The radio frequency front end of the wireless device of claim 12, wherein the one or more programs, which, when executed by the one or more computer processors, perform the operations further comprising, upon determining that the link budget does not satisfy one or more established criteria for region classification, identifying that the plurality of client devices is within a macro cell region of the wireless device.

17. The radio frequency front end of the wireless device of claim 16, wherein, to adjust the bypass threshold, the one or more programs, which, when executed by the one or more computer processors, perform the operations comprising, subsequent to identifying that the plurality of client devices is within the macro cell region of the wireless device, increasing the amplifier bypass threshold to a second value.

18. The radio frequency front end of the wireless device of claim 12, wherein the wireless device comprises at least one of an access point (AP) or a station (STA).

19. The radio frequency front end of the wireless device of claim 12, wherein the one or more programs, which, when executed by the one or more computer processors, perform the operations further comprising, upon determining that a signal strength associated with one of the received signals exceeds the bypass threshold, directing the signal to the bypass path within the one or more receiver chains.

20. One or more non-transitory computer-readable media containing, in any combination, computer program code, which, when executed by a computer system, performs operations comprising:
receiving, by a wireless device with one or more receiver chains, signals from a plurality of client devices;
estimating a link budget for the plurality of client devices, wherein the link budget indicates a quality of the signals received from the plurality of client devices; and
adjusting an amplifier bypass threshold for the one or more receiver chains based on the link budget.
